(19) United States
(12) Patent Application Publication
(10) Pub. No.: US 2025/0324135 A1
(43) Pub. Date: Oct. 16, 2025

(54) ZERO-SLATE FOR STREAMING PLATFORMS

(71) Applicant: M/S. Amagi Media Labs Pvt. Ltd, Bangalore (IN)

(72) Inventors: Baskar Subramanian, Bangalore (IN); Sashidhar Bangar, Bengaluru (IN); Veeresh Ashok Sanagoudar, Layout (IN); Santosh Padmanabha Hegde, Uttara Kannada (IN); Srinidhi Srinivasmurthy, Mysuru (IN); Koyyalamudi Rama Subhrahmanyam, Bengaluru (IN)

(73) Assignee: M/S. Amagi Media Labs Pvt. Ltd, Bangalore, KA (IN)

(21) Appl. No.: 19/177,525

(22) Filed: Apr. 12, 2025

Related U.S. Application Data
(60) Provisional application No. 63/633,472, filed on Apr. 12, 2024.

(51) Int. Cl. H04N 21/458; G06Q 30/0251; H04N 21/262; H04N 21/466; H04N 21/482

(52) U.S. Cl. CPC H04N 21/458; G06Q 30/0251; H04N 21/26258; H04N 21/4668; H04N 21/482

(57) ABSTRACT

A system, method and computer program for creating personalized linear channels with the ability to avoid slates/filler content during ad-breaks and manage viewer-specific ad loads with a Media Preparation System, a content decisioning system (CDS), an elastic playout system (EPS) and a replacement decisioning system (RDS) capable of operating in (i) content mode and (ii) replacement mode with the ability to a) avoid slates/filler content during ad-breaks and b) manage viewer-specific ad loads. The system consists of a) an EPG module providing the intended program guide of the channel, b) ad-marker data store providing ad-marker details on a per video asset, c) ready-to-transmit packaged video assets, d) per viewer channel assembly module, e) content decisioning server and f) ad decisioning server. The method is a mechanisms of the per-viewer decisions that determine specific content/ad that needs to be served to the end-user for the complete duration of the viewer session.

### CROSS REFERENCE TO RELATED APPLICATIONS

This application claims the benefit of and priority on U.S. Provisional Patent Application No. 63/633,472 having a filing date of 12 Apr. 2024.

### FIELD OF THE INVENTION

This invention relates to a zero-slate system within Free Ad-supported Streaming TV (FAST).

### BRIEF DESCRIPTION

With the advent of FAST (Free Ad-supported Streaming TV), viewers world-wide have adopted linear channel viewing habits on streaming devices such as connected TV, mobile devices, and any other Internet connected screens.

Given the free nature of content that is streamed, content providers and distribution platforms have leveraged targeted advertising as the model for monetizing the watched content.

There are hundreds of linear channels each, on these FAST platforms. All these channels are programmed through a schedule and published as EPG (Electronic Program Guide) on the distribution platforms, for viewers to discover channels.

All these channels are currently monetized by scheduling periodic ad-breaks on these linear channels. These ad-breaks are dynamically filled with targeted ads, on a per-viewer basis, as and when the viewer is viewing the channel and reaches the ad-break schedule in the channel. The scheduled ad-break duration and the number of ad-breaks in the content is determined by the distribution platform. The choice of the ad-breaks has key implications in terms of monetization and viewer experience. More ads repel viewers. Platforms and content owners try to balance the ad-loads to keep users and yet maximize monetization.

When a viewer is exposed to ad-breaks as part of the linear channel; in a typical implementation, a server-side ad-insertion system requests for targeted ads for each of the individual viewer ad-breaks. The ads returned for the individual viewer's ad-break are inserted into the linear stream for that viewer.

Given the growth of FAST and the number of subscribers watching ad-supported content, there are multiple ad opportunities in ad-breaks that do not receive any ads. This leads to a scenario of inserting slates/fillers in the unfilled duration. These slates/fillers are typically channel-specific promo or wheel/bumper content that is kept in place to engage the viewer until the linear content is back on schedule.

Over the last few years, it is seen that on an average close to 40%+ of ad opportunities across breaks are unfilled, leading to display of slates/fillers for those ad-break durations. The experience of watching repeated slates/fillers leads to a poor viewing experience, that prompts users to stop viewing or switch to other linear channels. At the linear channel level, this leads to viewer churn for that channel, and in the longer term leads to viewers leading to reduced viewership, and hence lesser overall ad monetization.

Also, the current systems of linear channel distribution penalize viewers who are loyal and watch for long, by showing more slates/fillers, and leads to ad fatigue for the most loyal viewers.

To counter this ad-fatigue, the defined system in this invention avoids showing slates/fillers for viewers. The core idea of the invention is to manage the ad loads of each of the viewer, by creating personalized linear streams for each of the viewer; complying close to program schedules of the linear channels and avoid showing any slates/fillers. This leads to unique individualized linear streams per user. This is a win-win for the entire ecosystem, where content owners, distribution platforms and viewers avoid the unwanted slates/fillers that were non-value-added for all.

We propose a system method and computer program product with zero-slates for linear TV. The system comprises five main components including a Media Preparation module, an auto segmentation module, an Elastic Playout module, a Content Decisioning module and a Replacement Decisioning module. The method comprises the steps of preparing the media, deciding how to set up a zero-slate experience for the user by interaction with an elastic playout module, a content decisioning module and a replacement decisioning module and rendering the content to the user without any slates or ledes thereby ameliorating ad fatigue and creating a seamless viewing experience. In our disclosure, when we mention specific intervals of ‘x’ minutes or ‘y’ hours, we maintain that these are only exemplary and are always configurable on a case-by-case basis.

ZS functionality depends on being able to work properly with following systems

| Product/Tool | ZS integration |
|---|---|
| Media Asset | In order to fetch content assets ahead of |
| Management | time and as per schedule |
| EPG & Tornado | In order to understand where ad breaks are |
| | located in the program time |
| Server Side Ad | In order to understand where the ad assets are to be |
| Insertion | sourced from |

ZS recreates the stream based on the current schedule. In order to be current and proof of any changes in schedule ‘x’ hours' worth of scheduled playlist is fetched ‘y’ mins prior to actual program start. This gives it enough time to fetch segments ahead of time and understand how to generate the stream in case ads returned do not fill the complete pod.

During runtime, when user fetches the content, ZS builds asset based playout on the fly, requests ads at the time ad breaks are scheduled and switches back to content as soon as ads finish playing (in case of no ads, immediately). As the first step, ZS uses SCTE markers to understand ad break durations. However, since ZS is shaping ad duration by eliminating slates, it can also control pod shaping which is dynamically stretching or compressing ad breaks to meet given guidelines. ZS will allow following controls around ad breaks including Pod Shaping enablement that have the following controls including the number of ad breaks in an hour, determining how far apart the ad breaks need to be and the maximum duration of an ad break. Based on these ZS can dynamically add ad breaks in order to meet ad load guidelines and provide a seamless experience. ZS performance is analyzed by instrumenting the following metrics (in addition to other channel or ad performance metrics) to ensure ZS value add is provided in a clear cut fashion (a) Analytics integration wherein ZS will integrate with Amagi Analytics for both Viewership and Ads analytics, (b) Operational metrics which include system integration stats such as request/response, timing, assets, latency etc., (c) System processing stats including assets, timing, latency, ads, deliveries, (d) Product metrics including user/session metrics such as watch minutes and content/ads at aggregate and (e) Experimental metrics including watch minutes for A/B testing. In case there is any ZS issue, enough monitoring will be in place to disable ZS and address any drift introduced.

ZS sources filler assets from the following pools. Filler assets can be provided as VAST URLs (VAST XMLs) via URL. They can also be prioritized (e.g. first try a promo, then house ad etc.). Some of these assets can also be replayed to fill the drift so created. Hence hard duration requirements are eased.
Ads—additional VAST tags
Fillers—ranging from seconds to minutes
House ads
Promo Content of any duration up to a specified upper limit.

This experience is similar to how content is shown when a live event such as sport ends earlier than expected.

ZS is the first use case of Personalization wherein Amati exhibits following fundamental functionality required for future use cases:
Generating personalized ad inserted stream with varied ad loads;
Experimental framework to do A/B testing at scale;
Solving for drift in program schedule for various duration cases that arise e.g. after ‘x’ hours of reruns, a live sports event begins, which means all users have to mandatorily join at that time to the exact frame.

Thus doing ZS enables the success of subsequent personalization use cases such as—
1. SVOD>AVOD viewers—e.g. skip ads for first hour to keep engagements high, and subsequently ramp up ad load time; and
2. Roadblocks and Sponsorships—e.g.ads sponsored by a brand, thereby ad loads are lower than usual for a cohort of users.

Once Amagi ZS functionality can run A/B tests as well as solves for any drift issues, launching such use cases becomes easier from both functionality (edge cases) and testability point of view. In order to ensure unbiased experiments and data, ZS will allow running A/B test at a delivery level. Further, the auto segmentation module can use Machine Learning components to detect scene boundaries in content to allow multiple options into the program content to introduce ad breaks.

In addition, our system has the ability to perform a start over of the current show or skip to the next show. Within the user's content buffer, triggers are sent to the player, allowing users to start over the currently running show or skip to the next show in the user's content buffer. These are additional features that are offered by the ZeroSlate.

This ZeroSlate system can also work with live streams. The live streams are buffered for a certain window length customizable. The output from ZeroSlate is delayed by this duration. The SCTEs in the live streams are used as break opportunities. Within the duration of the delayed window, the ZeroSlate experience is provided to the users. Once the delayed buffer is exhausted, as the content is pulled up for the duration of unfilled break opportunities, the ZeroSlate behaves like the regular SSAI. The delay for a live channel is configurable. Some customers can use the time shift features of the playout system to give a stream 1-2 hours in advance. Using such a time-shift feature makes sure that the stream is in sync with the EPG.

### BACKGROUND AND PRIOR ART

U.S. Pat. No. 10,979,775 titled ‘Seamless Switching from a Linear to a Personalized Video Stream’ discloses a method for seamless switching between linear and personalized video streams on a client device. The system allows the current linear video to finish before transitioning, ensuring uninterrupted viewing. Switching signals, embedded data, or content analysis determine transition timing. Users interact with the content through likes, skips, or volume changes, which inform future personalization. This hybrid model enhances user experience by blending passive viewing with personalized recommendations and supports both smart TVs and legacy set-top boxes, optimizing bandwidth and device compatibility.

US20150113570A1 titled ‘System and Method for Personalized TV’ discloses a system that personalizes TV content using metadata-driven segmentation and viewer preference analysis. By applying Bayesian and regression models, the system predicts and refines individual tastes. Users interact via likes, skips, or program selection, which updates their profiles. It supports multi-user environments, interactive content, and dynamic ad placement based on demographics. Closed captioning, EPG integration, and automated recording are also included. The system modernizes traditional television by introducing AI-driven content curation, allowing for a more relevant and responsive viewing experience across households and devices.

U.S. Pat. No. 11,051,061 titled ‘Publishing a Disparate Live Media Output Stream Using Pre-Encoded Media Assets’ discloses a system that simulates live broadcasts using pre-encoded VOD content. A network scheduler provides a program lineup, and the system builds a live output stream by inserting media segments into a manifest. This reduces infrastructure needs while supporting seamless content transitions and ad insertions. Content is validated and indexed to enable reliable playback. The method is ideal for scalable digital broadcasting and pop-up channels, enabling efficient delivery of live-like experiences without real-time encoding or centralized broadcast hardware.

U.S. Pat. No. 11,671,641 titled ‘Publishing disparate live media output streams in mixed mode’ discloses a system for generating compliant live media streams using real-time schedule updates and stream previews. Operators monitor low-latency feeds to adjust schedules dynamically, enabling seamless transitions between live and pre-encoded assets. The system edits manifests and integrates compliance elements such as ads, closed captions, and stream validation. Virtual control replaces traditional broadcast equipment, allowing remote operation and real-time responsiveness. This innovation enables software-defined content delivery workflows, offering flexible, cost-efficient alternatives for broadcasters who need to adapt to live events while meeting regulatory standards.

U.S. Pat. No. 11,483,607 titled ‘Publishing a Disparate Live Media Output Stream that Complies with Distribution Format Regulations’ discloses a system for composing live streams from live feeds and pre-encoded assets while ensuring compliance with formatting rules. A virtual production control interface allows operators to preview streams and update content schedules in real time. The system supports ad insertions, captions, interstitials, and stream editing. By manipulating manifests, it guides compliant playback across devices. This eliminates the need for central broadcast hardware, enabling agile, regulation-friendly streaming workflows ideal for cloud-based and digital-first distribution platforms.

### BRIEF DESCRIPTION OF THE DRAWINGS

FIG. 1 describes the state of the art in SSAI.

FIG. 2 shows a sample Electronic Programming Guide (EPG).

FIG. 3 describes how the Zero Slate linear TV system works as opposed to the state of the art.

FIG. 3a shows the Zero Slate linear TV system's media asset layout for one or more users.

FIG. 4 shows the overall system for Zero Slate linear TV.

FIG. 4a shows the system in more detail.

FIG. 5 shows the Media Preparation sub-component for Zero Slate linear TV.

FIG. 5a shows the metadata representation within the media preparation sub-component.

FIG. 6 shows the Elastic Playout (EPS) sub-component.

FIGS. 6a-h shows the update of user state and manifest in the EPS.

FIG. 7 shows the Content Decisioning Engine.

FIG. 8 shows the Replacement Decisioning Engine.

FIG. 9 shows the overall method for the present invention.

### DETAILED DESCRIPTION OF PREFERRED EMBODIMENTS

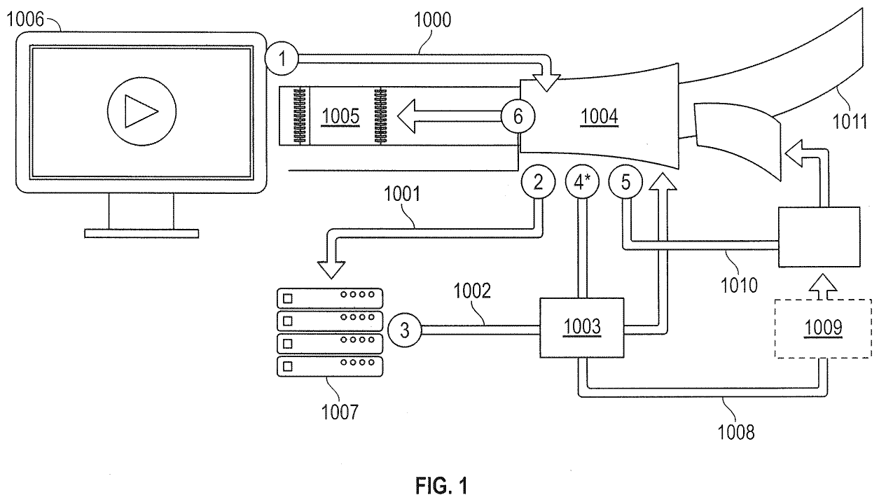

FIG. 1 describes the state of the art in SSAI. A playout system takes an EPG as input and plays the Media assets in the order that is specified in the EPG. The output from the playout system is given as input to an SSAI system, which replaces the ad markers with personalized ads for a user. A video content publisher 1006 requests an ad 1000 from an ad stitching service 1004. Ads 5 and content 1111 are inputs to this ad stitching service, in addition to VAST messages 1003. Transcoded ads 1110, VAST messages 1003, 4 and VAST requests 1001, 2 from an ad server 1007 arrive at the at stitching service 1004 where they are stitched into the content stream 1005 before being sent back to the Video Content Publisher 1006. Additionally, there is a mezzanine level 1009 where ad content might dwell after being transcoded. 1002 describes sending VAST signals. 1008 describes extracting mezzanine and transcoding.

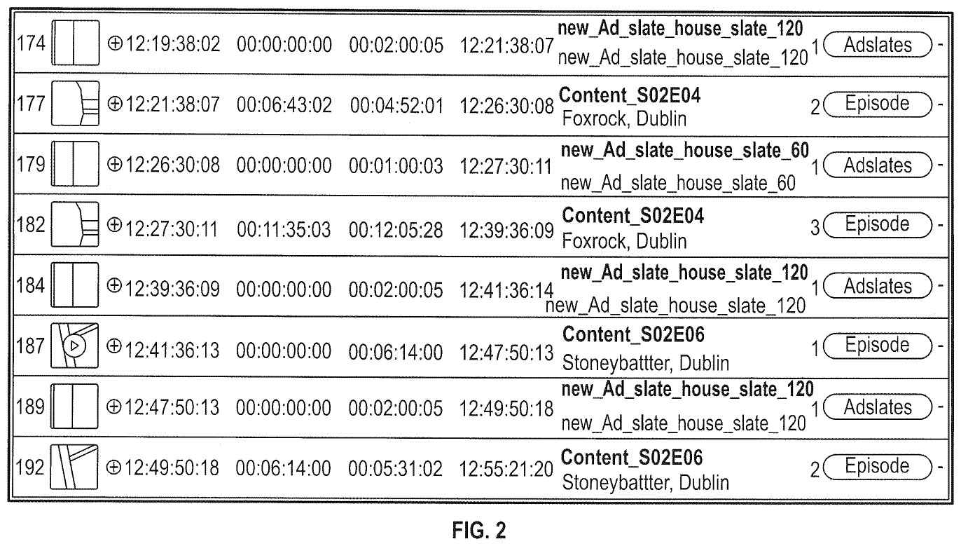

FIG. 2 shows a sample EPG. The playout system plays out the stream in the order which is specified in the EPG. The playout system also ensures that the ad-markers are sent in the output (HLS, DASH, etc.). The output from above is fed as input to SSAI which replaces ads.

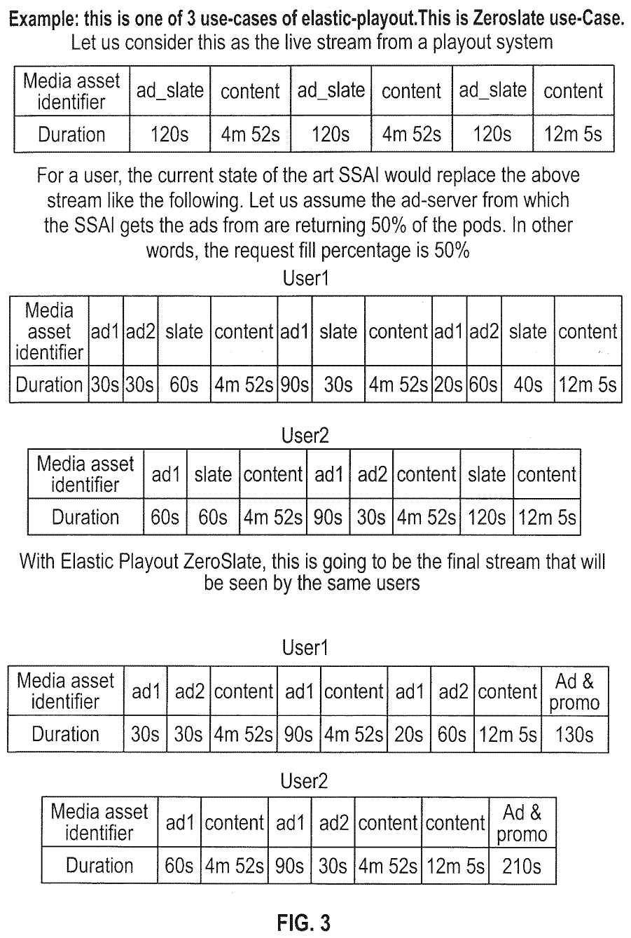

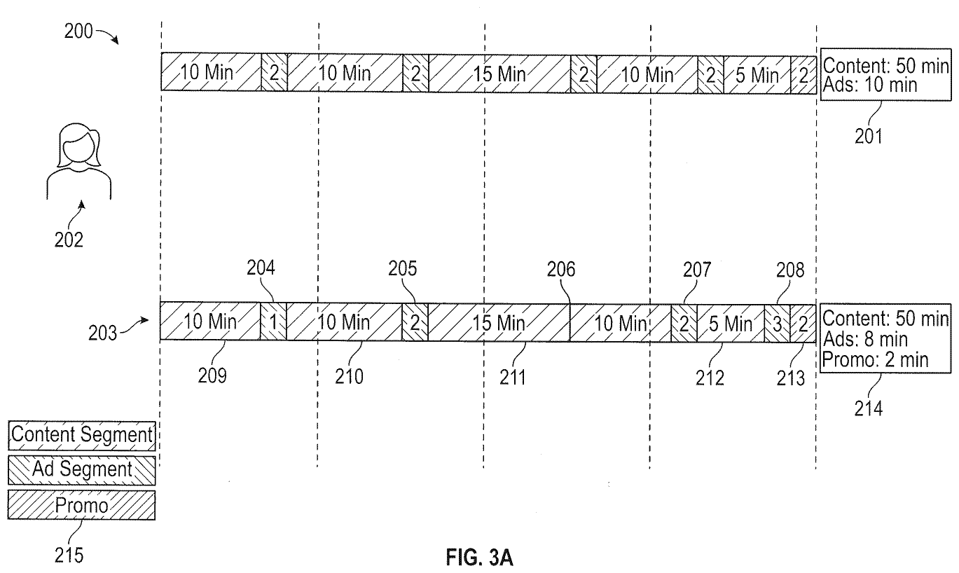

FIG. 3 describes how the Zero Slate linear TV system works as opposed to the state of the art. Users request Elastic Playout System for a live stream. In live-streaming, the clients keep polling the CDN every x seconds as long as the user/player is active.

FIG. 3a shows the Zero Slate linear TV system's media asset layout for one or more users 202. There is a regular schedule 200 where there is 50 minutes of content and 10 minutes of ads 201. We also depict the zero slate experience with skipped ad duration in the end 203 where in there is 50 minutes of content, 8 mins of ads and 2 mins of promotions 214. Ads are filled for different durations 1 mins, 2 mins, etc. 204, 205, 207. In addition, a first content segment is played 209, a second segment is pulled forward and played completely 210, a third segment is pulled ahead 211. Ad breaks are filled 208, promos are played towards the end 213, lost content segments are also played 212. 206 describes skipping an ad break and pulling the segment ahead. Ad break skipped and for the segment is pulled ahead. 215 describes a block containing a content segment, an ad segment or a promo.

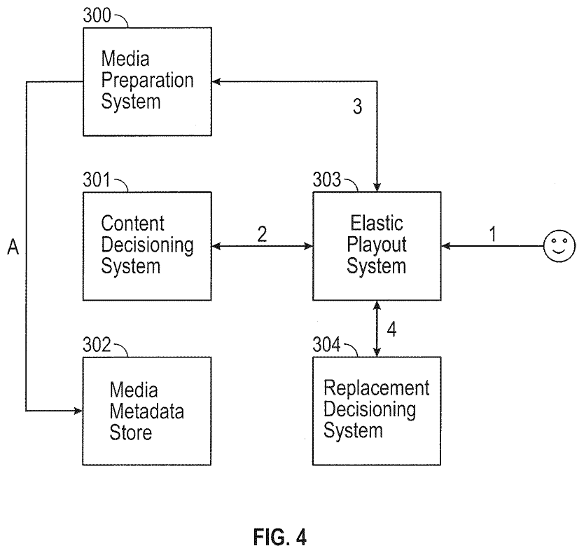

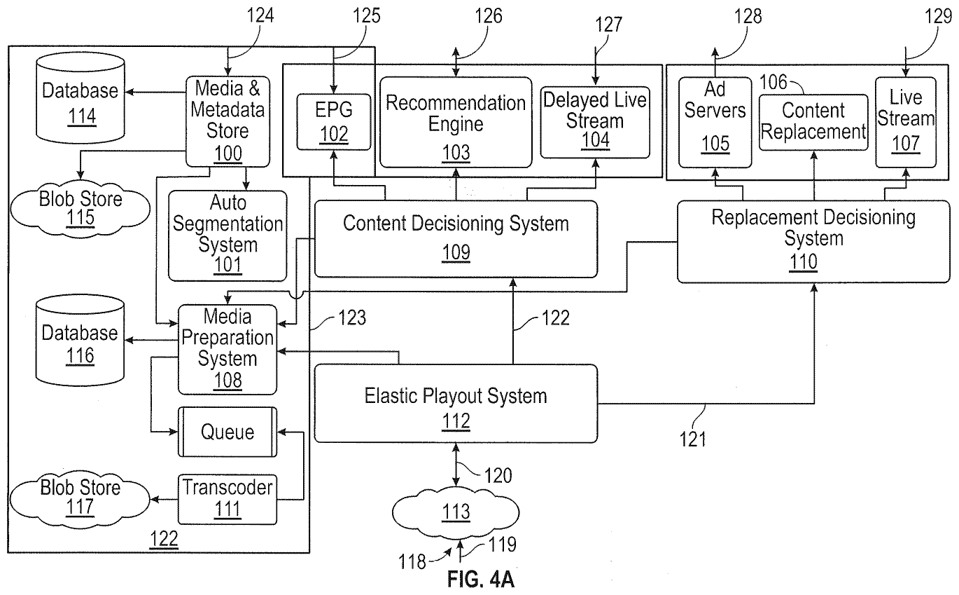

FIG. 4 shows the overall system for Zero Slate linear TV comprising a Media Preparation System 300, a content decisioning system 301, an elastic playout system 303, a replacement decisioning system 304 and a media metadata store 302.

FIG. 4a shows the overall system for Zero Slate Linear TV further comprising the modules for Media Preparation, Auto segmentation, Elastic Playout, Content Decisioning and Replacement Decisioning. There are several components including the Ingest Media 100, EPG ingest 101, one or more recommendation engines 102, input live streams 103, an Ad network 104, and an input live stream 105. 101 interacts with a media and metadata store 107, which works with a database 106, a blog store 115, an auto-segmentation system 116 and a media preparation system 120 that interacts with the elastic layout system 124 and also with a database 119 and a queue 123. A transcoder 126 interacts with the queue 123 and a blob store 125. The EPG ingest 101 interacts with a global EPG 108, which receives inputs from a content decisioning system 117. One or more recommendation engines 102 interact with one or more third-party or in-house recommendation engines 109, which also interact with the content decisioning system 117. An input live stream 103 interacts with a delayed global live stream 110 which also interacts with the content decisioning system 117. There is an ad network 104 which interacts with one or more third-party ad servers 112, a content replacement block 113 and an input live stream 105 that interacts with a live stream 114. All these components 112, 113 and 114, interact with the replacement decisioning engine 118. One or more users 128 with Channel_IDs interact with a global content distribution network (CDN) 127 which works with an elastic playout system 124 in fetching manifests from their origin 130

The Elastic Playout System 124 converts an array of media assets to a live stream works with the Media Preparation System 120 sending segmented content segments for media 121, the Content Decisioning System 117 where it gets program content, Channel_ID, pass user's details (IP, UserAgent, DeviceID, etc.) 122 and the Replacement Decisioning System 118 where it sends replacement content including Channel_ID, Pass User's Details (IP, User Agent, Device ID, etc.) 131.

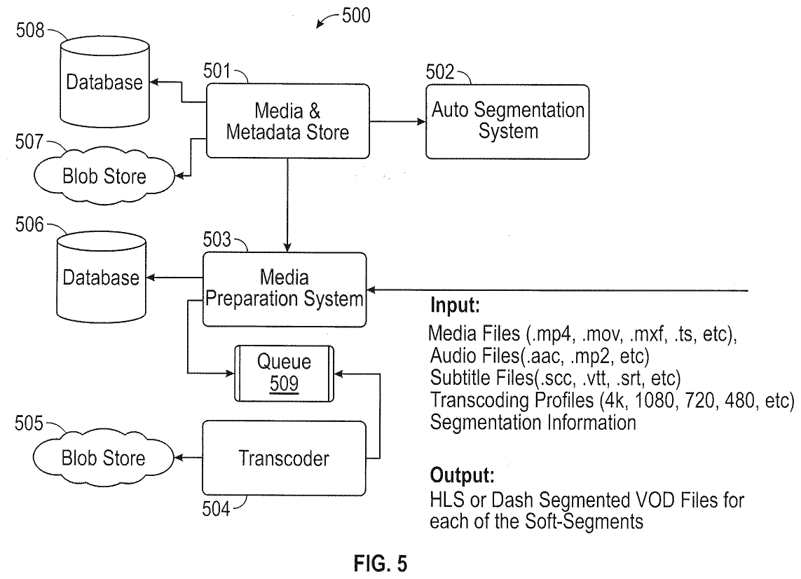

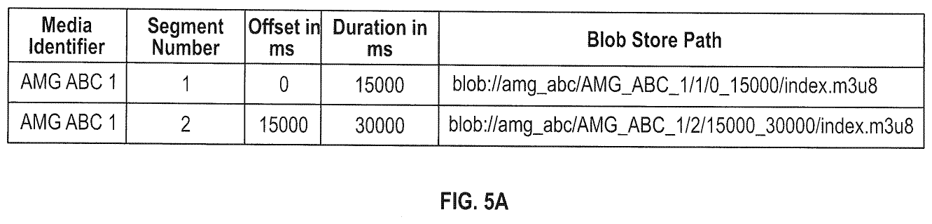

FIG. 5 shows the Media Preparation module 500 for Zero Slate linear TV. This further comprises a media and metadata store 501, an auto segmentation system 502, a media preparation system 503, a queue 509 and a transcoder 504. The Media Preparation module takes as inputs one or more downloadable URLs, various other sidecars (subtitles, audios, URLs), segmentation information, destination path where the transcoded asset has to be uploaded, transcoding profile information, various other transcoding parameters. The media preparation module then outputs segmented media segments that are uploaded to the destination path and notifications are sent upstream about the status of the job. The media preparation module uses the Media, the sidecars, transcoding profiles and its corresponding metadata like segment information to precondition the media into streamable segments. The adaptive bitrate ladder for that media, chopping the media and subtitles at soft-segment boundaries are the responsibilities of this system. The soft-segmentation information that comes as input is used to precondition the media into chunks of segments. These segments are uploaded to a Blob store 507 and the entries are made in the database 508. For a given Channel_ID, the transcoding profiles are all predetermined. These configurations for a Channel_ID exist with the media preparation system. The customer ingests Media, associated sidecars and metadata containing segmentation information to Amagi. These are stored in a Blob store and the corresponding URLs are stored in the database 506. This module is described in detail in US Patent U.S. Pat. No. 10,469,882B2 titled “System and method of server-side ad insertion for over the top (OTT) streams”.

In addition, the system auto-generated segmentation information using an ML-based system. ML models are used to detect scene boundaries in content to allow multiple options int the program content to introduce ad breaks. Various other algorithms utilizing scene changes, audio changes, and/or subtitles are used to determine the advertisement break points. This provides oversampled replacement opportunities that allow the replacement decisioning module to leverage and effect interesting replacement policies. Metadata is generated that marks the content offset with respect to the start of media content where there is a scene change or audio change, which provides a replacement opportunity. This information is also stored as an associated metadata of the Media in Metadata store. The metadata store component then triggers a transcoding and segmentation workflow for the newly created or updated media assets. Any changes to any of the sidecars or metadata also retrigger the transcoding workflow. The transcoder uses transcoding profiles to create ABR ladder for the media assets. The segmentation information is used to cleanly chop the ABR segmented assets at their segmentation boundaries. The corresponding sidecar assets are also chopped at the segment boundaries. Once the segmentation is completed, the corresponding index/master manifest of the individual soft-segmented assets is uploaded to blob store 505. The corresponding soft-segment information to blob store URL link is stored in the database. The segmented manifest is either in HLS or DASH format. Further, the Media Preparation system 503 returns a sequence of segments which fall within segment offset and segment duration in the Media. This system gets called by the Media & Metadata store 501 as and whenever there is a change or addition to any of the aspects of a Media.

FIG. 5a shows the metadata representation within the media preparation sub-component comprising a media identifier, segment number, offset, duration and a blob store path amongst other information.

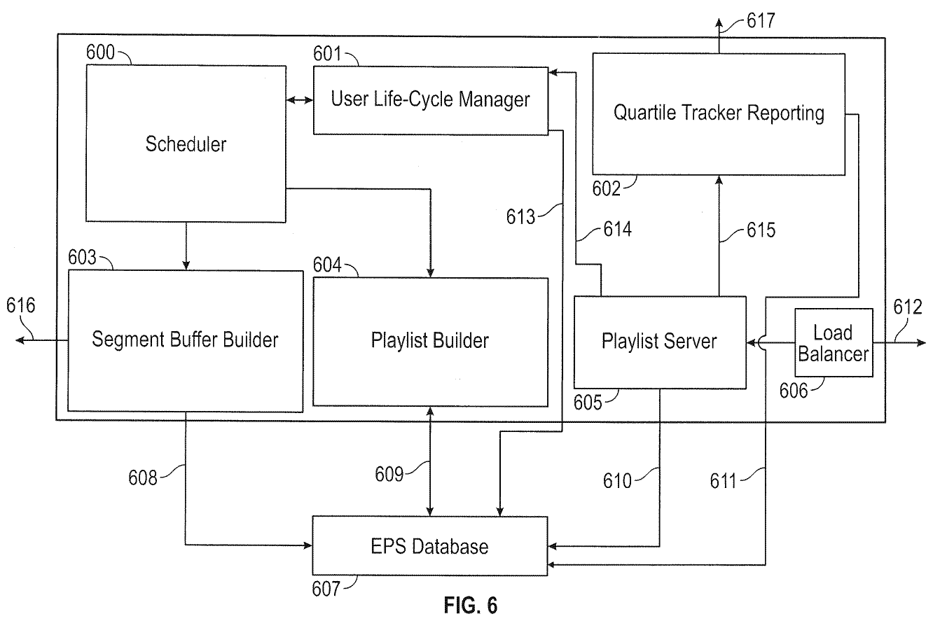

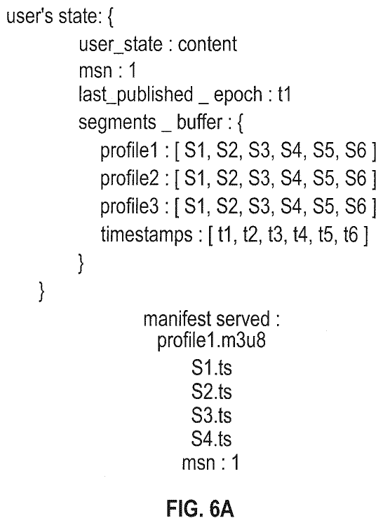

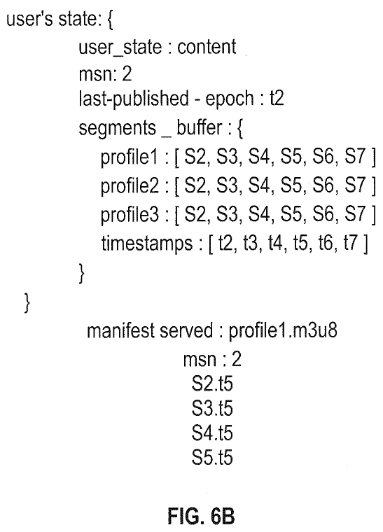

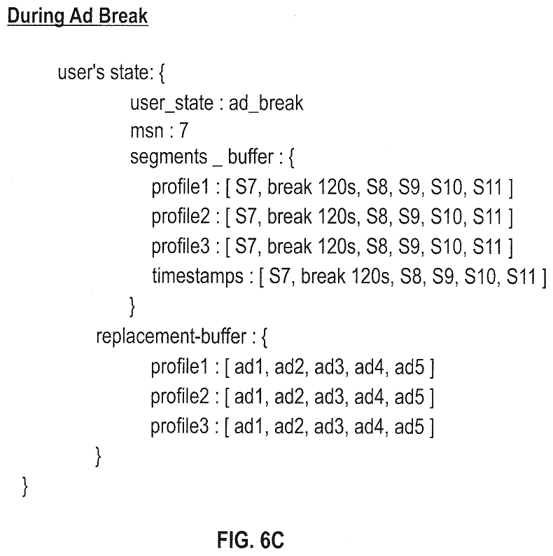

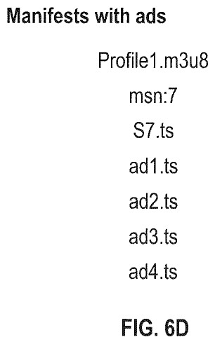

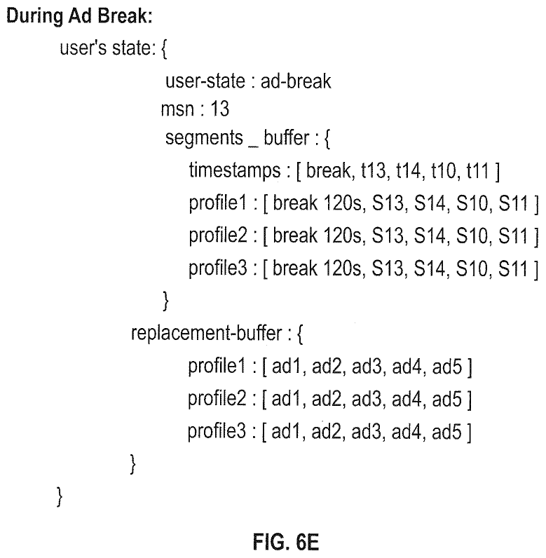

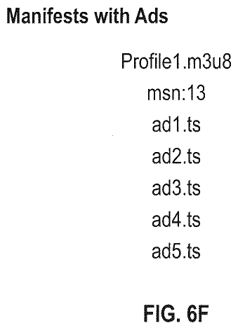

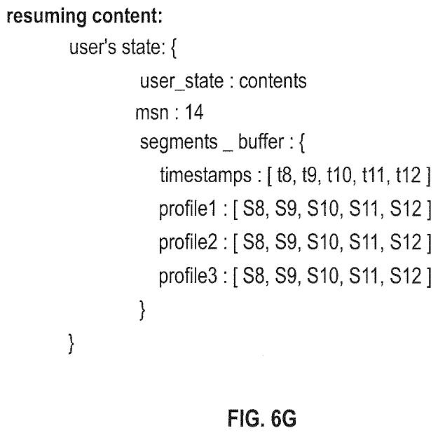

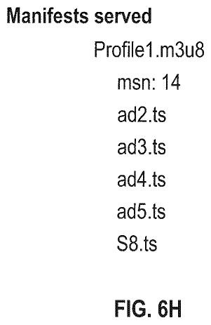

FIG. 6 shows the Elastic Playout sub-component further comprising a scheduler 600, a segment buffer builder 603 which prepares content from the content decisioning system or the replacement decisioning system 616, a user life-cycle manager 601, a playlist builder 604, a playlist server 605, a quartile tracker reporting sub-system 602 interacting with one or more ad servers' quartile trackers 617 and the EPS database to get quartiles URLs for the user and the ad 611. A load balancer 606 which requests users manifests 612, and an EPS database 607. The scheduler 600 triggers the playlist builder to build a manifest for active users. It also triggers the segment buffer builder to extend the buffer if it is about to be exhausted and the segment buffer builder 603 in turn communicates with the EPS database 607 to set or extend a user's segment buffer by fetching from the content decisioning system or replacement decisioning system 608. Content decisioning system and replacement decisioning system also trigger this system to make sure that transcoding spec of the rest of the content that they get from other sources match the main content that is intended to be played out. Elastic Playout System (EPS) consults the Content Decisioning System (CDS) for the content to play to this user, passing user identifiers. CDS returns an array of content to stitch to the user, along with replacement markers indicating actions such as switching to a live event, stitching personalized ads, or replacing content. The playlist builder 604 further exchanges user's state to manipulate and store the user's segment buffer 609. The user life-cycle manager 601 also interacts with the EPS database 607 to store and periodically update user activity 613. The Playlist server 605 interacts with the EPS database 607 to fetch a user's manifest from the database 610, with the user life-cycle manager 601 to record user activity and user details 614 and with the quartile tracker reporting sub-system 602 to send the ad quartile that the user has viewed 615.

FIGS. 6a-h shows show the updating of user state and manifest in the EPS. FIGS. 6a to 6h describe an example where a HLS manifest is stitched and sent to the users using EPG as the CDS source. A reference timestamps from the EPG and the corresponding segments to be served to the users is kept as user's segments buffer. The system keeps track of the life cycle of a user. As long as a user is watching the stream, the system moves the manifest by 1 segment every segment duration—for a 6 s segments, the manifests are built. Between FIGS. 6A and 6B, an example is shown where the MSN moves ahead by 1 and a new segment is appended to the manifest and an older segment is popped out at the top. FIG. 6c shows a case when there is break in the manifest, ZeroSlate uses the RDS system to get the corresponding for the user and fills up the replacement-buffer. During the ad-break, the ZeroSlate system switches to break mode and starts building the manifest with replacement-buffer. FIG. 6D shows an example of ads being inserted in the manifest. Based on the protocols being used, the ZeroSlate system makes sure the discontinuity tags are added in the manifest. Once the ad break is completed, FIG. 6g shows the switch to the content. The MSN and segments buffer continue to show the next set of content segments.

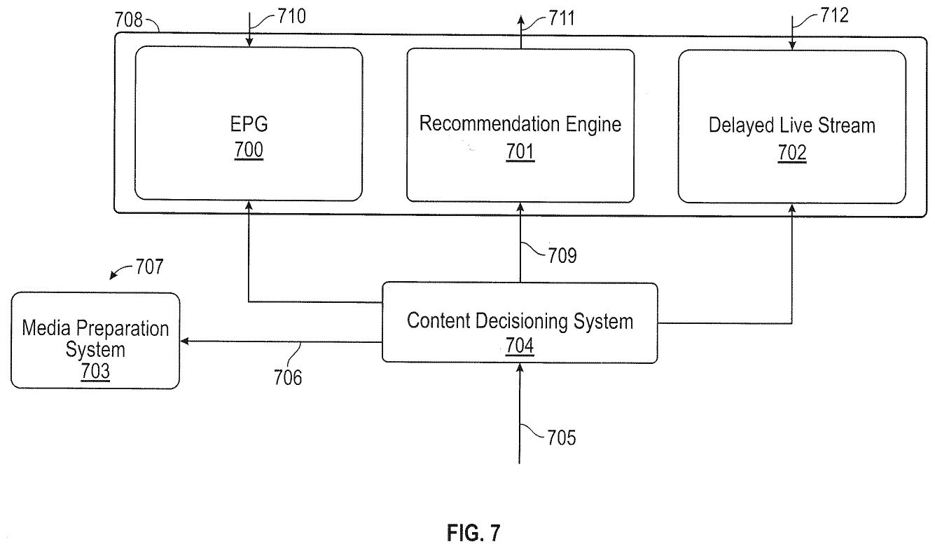

FIG. 7 shows the Content Decisioning Engine which has one or more decisioning engines 708. This for the comprises an EPG 700, a Recommendation Engine 701, a Delayed Live Stream 702, a Content Decisioning System 704 and a Media Preparation System 703. The EPG 700 takes in an EPG ingest 710 and parses the EPG responses into a timeline of assets. When requested, it returns the media that is supposed to be played out at the current time. The Recommendation Engine 701 parses the response from one or more recommendation engines 711 into an internal standardized format. The Delayed Live Stream 702 parses live HLS, DASH or equivalent sources from input live streams 712 and brings them into an internal standardized format. The Content Decisioning System 704 interacts with the EPG 700, the Recommendation Engine 701 and the Delayed Live Stream 702, exchanging an array of media to stitch for a user 709. It further interacts with the Media Preparation System 703 to get or enqueue items for transcoding 706. The Media Preparation System 703 checks if a media is already transcoded, failing which it enqueues it in a transcoding queue 707. The content Decisioning system 704 gets program content including Channel_ID, pass users details, user agent, device Id etc.

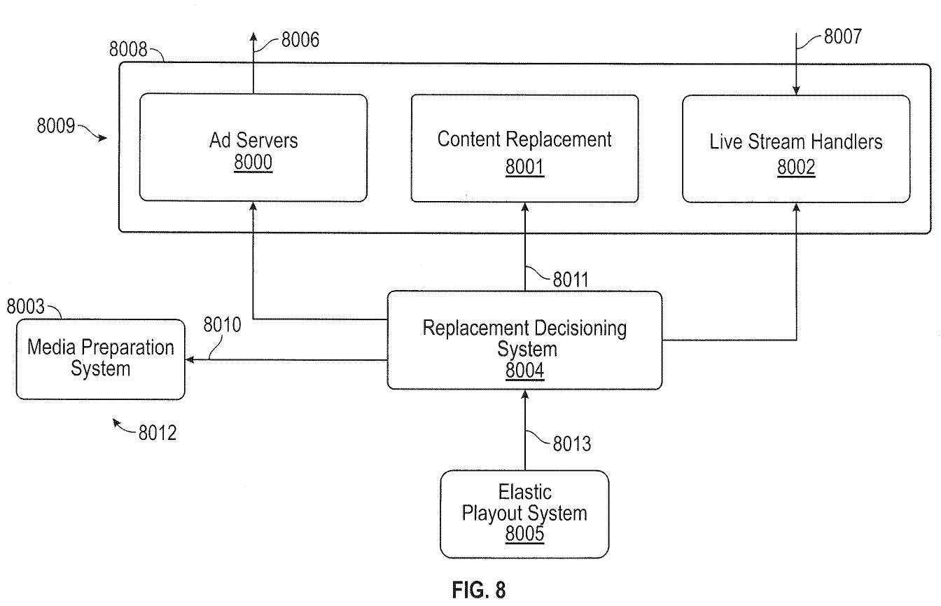

FIG. 8 shows the Replacement Decisioning Engine comprising one or more replacement engines 8009 including Ad Servers 8000, a content replacement module 8001, one or more livestream handlers 8002, a regional replacement decisioning system 8004, a media preparation system 8003 and an elastic playout system 8005. The Ad Servers 8000 interact with one or more ad networks including GAM, PubMatic, etc. 8006 communicating in VAST/VMAP responses 8008. The Live Stream Handlers 8002 parse the live HLS, DASH or equivalent sources of input live streams 8007 and bring them into an internal standardized format. The Replacement Decisioning System 8004 interacts with Ad Servers 8000, the content replacement module 8001, and one or more live stream handlers 8002 with an array of media to stitch for a user 8011. It also interacts with a Media Preparation System 8003 to get or enqueue segments to transcode 8010 and an Elastic Playout System (EPS) 8005 to get replacement content 8013. The Media Preparation System 8003 checks if a media is already transcoded, failing which it enqueues it in a transcoding queue 8012. When the system talks to CDS it will be content mode and when its talking to RDS is will be replacement mode.

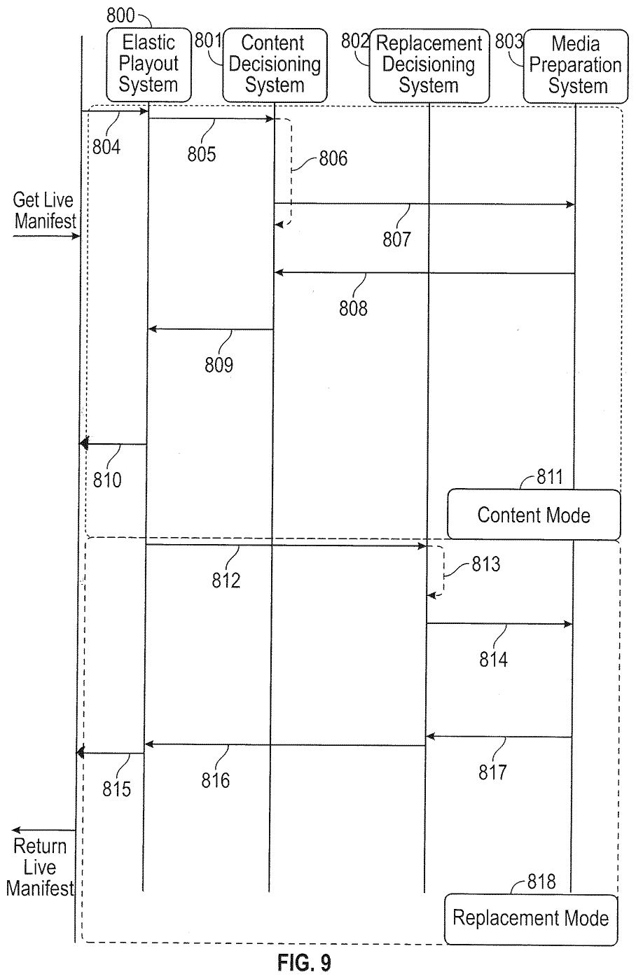

FIG. 9 discloses a computer-implemented method for zero-slate, within Free Ad-supported Streaming TV (FAST) for creating personalized linear channels with the ability to avoid slates/filler content during ad-breaks and manage viewer-specific ad loads with one input 804 and one output (either of 810 or 815 depending on the operating mode) and further comprising (a) a Media Preparation System 803, (b) a content decisioning system (CDS) 801, (c) an elastic playout system (EPS) 800, and (d) a replacement decisioning system (RDS) 802, capable of operating in (i) content mode and (ii) replacement mode. The method has the following steps—

In content mode 811, the user requests EPS for a live manifest 804. The EPS requests CDS 805 for assets to play in the present time window. The CDS talking to a decisioning engine 806 to get the corresponding assets. The CDS gets one or more corresponding segments from the Media Preparation System 807. The Media Preparation System responding 808 with one or more transcoded segments for the request 807. The CDS responds 809 with segments to the EPS in response to 805. Finally, the EPS builds a new playlist for the user request 804 and responds with the live manifest 810.

In replacement mode 818, the method changes to the user requesting EPS for a live manifest 804 and the EPS requesting RDS 812 for assets to play in the present time window. The RDS talking to a replacement engine 813 to get the corresponding assets. The RDS gets one or more corresponding segments from the Media Preparation System 814. The Media Preparation System responding 817 with one or more transcoded segments for the request 814. The RDS responds 816 with segments to the EPS in response to 812 and finally, the EPS builds a new playlist for the user request 804 and responds with the live manifest 810.

This figure also shows the overall method for the present invention including the creation of personalized ad breaks, means to shape ad breaks to cater to non-availability of ads for certain users, means to reset the live media stream to match the original EPG module, means for signal reset to reset streaming selectively for specific assets using in band SCTE signaling, means to declare a reset timeline as a configuration parameter where if the drift time exceeds a pre-configured duration then a reset is triggered. Means to declare a reset timeline as a configuration parameter where if the drift time exceeds a pre-configured duration, it triggers a reset. A drift timeline is maintained encapsulating the drift between a specific user and the corresponding original EPG timeline. The method can further auto fill the drift duration with interesting content from the content owner's catalog.

This method works with four components, the Elastic Playout System (EPS) 800, the Content Decisioning System 801, the replacement decisioning system 802, and the media preparation system 803. Each component has a set of inputs and outputs.

The EPS 800 receives a live manifest for the channel manifest for User requests the channel the manifest every X seconds as long as the their session is active 804. The EPS 800 also receives a Return array of replacement segments to stitch which matches the channel's transcoding spec 816 from the Replacement Decisioning Engine 802. The outputs of the EPS include a ‘Get live manifest for the channel’ 805, a ‘Get replacement content for this user and channel’ 812, a Return live stream HLS or DASH manifest for the user 810 and a Return live stream HLS or dash manifest for the user with replaced content 815.

The Content Decisioning System 801 has two inputs a Get live manifest for the channel 805 and a Return array of segments for the content assets matching the channel's transcoding profiles 808 and two outputs-a Get segments from the content assets matching the channel's transcoding profiles 807, a Return array of segments to stitch for channel's transcoding profiles including the replacement markers 809.

The Replacement Decisioning System 802 has two inputs a Get replacement content for this user and channel 812, a Return array of segments for the content assets matching the channel's transcoding profiles 817 and two outputs a Get segments from the ad assets matching the channel's transcoding profiles 814, a Return array of replacement segments to stitch which matches the channel's transcoding spec 816.

The Media Preparation System 803 has two inputs-a Get segments from the content assets matching the channel's transcoding profiles 807, a Get segments from the ad assets matching the channel's transcoding profiles 814 and two outputs-a Return array of segments for the content assets matching the channel's transcoding profiles 808, a Return array of segments for the content assets matching the channel's transcoding profiles 817.

We also disclose a non-transitory, machine-readable storage medium having stored there on a computer program for zero-slate, within Free Ad-supported Streaming TV (FAST) for creating personalized linear channels with the ability to avoid slates/filler content during ad-breaks and manage viewer-specific ad loads, the computer program comprising a set of instructions for causing a machine to perform the steps of the method described in FIG. 9.

We also provide a legend below with part numbers and descriptions, detailing the attributes in each exchange in many cases, for clarity, completeness and conciseness.

### Legend with Reference Numerals and Descriptions

| Figure | Part | Description |
|---|---|---|
| 1 | 1000 | Publisher requests ad |
| | 1001 | Request VAST |
| | 1002 | Send VAST |
| | 1003 | VAST |
| | 1004 | Ad-Stitching service |
| | 1005 | Ad |
| | 1006 | Video Content Publisher |
| | 1007 | AD Server |
| | 1008 | EXTRACT MEZZANINE AND TRANSCODE |
| | 1009 | Mezzanine |
| 3A | 200 | Regular Schedule |
| | 201 | Content:50 min Ads: 10 min |
| | 202 | Viewer joining at the start of the program |
| | 203 | Zsiate Experience with skipped ad duration in the end |
| | 204 | Ad filed only for 1 min |
| | 205 | ad filed only for 2 min |
| | 206 | Ad break skipped and for the and segment is pulled ahead |
| | 207 | Ad filed for 2 min |
| | 208 | Ad break of 2 min is filled |
| | 209 | 1st content segment is played |
| | 210 | Second segment is pulled forward and played completely |
| | 211 | Third segment is pulled ahead |
| | | Last content segment is played |
| | 213 | 2 min of promo played in the end |
| | 214 | Content: 50 min Ads: 8 min Promo: 2 min |
| 4 | 300 | Media Preparation System |
| | 301 | Content Decisioning System |
| | 302 | Media Metadata Store |
| | 303 | Elastic Playout System |
| | 304 | Replacement Decisioning System |
| 4a | 100 | Media & Metadata Store |
| | 101 | Auto Segmentation system |
| | 102 | EPG |
| | 103 | Recommendation Engine |
| | 104 | Delayed Live Stream |
| | 105 | Ad Servers |
| | 106 | Content Replacement |
| | 107 | Live Stream |
| | 108 | Media Preparation System |
| | 109 | Content Decisioning System |
| | 110 | Replacement Decisioning System |
| | 111 | Transcoder |
| | 112 | Elastic Playout System Convert array |
| | | of media asset to a live stream |
| | 113 | CDN |
| | 114 | Database |
| | 115 | Blob Store |
| | 116 | Database |
| | 117 | Blob Store |
| | 118 | Users ID |
| | 119 | Fetch manifest |
| | 120 | Fetch manifest from origin |
| | 121 | Get replacement content (channel ID, pass user's details) |
| | 122 | CMS |
| 5 | 500 | Ingest Media and/or Metadata |
| | 501 | Media & Metadata Store |
| | 502 | Auto segmentation system |
| | 503 | Media Preparation System |
| | 504 | Transcoder |
| | 505 | Blob Store |
| | 506 | Database |
| | 507 | Blob Store |
| | 508 | Database |
| | 509 | Queue |
| 6 | 600 | Scheduler |
| | 601 | Use Life Cycle Manager |
| | 602 | Quartile Tracker Reporting |
| | 603 | Segment Buffer Builder |
| | 604 | Playlist Builder |
| | 605 | Playlist Server |
| | 606 | Load Balancer |
| | 607 | EPS Database |
| | 608 | Set of extend user's segment |
| | | buffer by fetching front content or |
| | | replacement decisioning engines |
| | | Get user's state, user's segment |
| | | buffer and store the finally built |
| | | manifest |
| | 610 | Fetch user's manifest from database |
| | 611 | Get quartiles URLs for the user and the ad |
| | 612 | Request manifest for an user |
| | | and in Channel_ID. User details, |
| | | device details, Query parameters are sent |
| | 613 | Store & also periodically update user activity |
| | 614 | Record user activity and user details |
| | 615 | Ad quartile that the user viewed |
| | 616 | Get content from content decisioning |
| | | system or replacement decisioning system |
| 7 | 700 | EPG |
| | 701 | Recommendation Engine |
| | 702 | Delayed Live Stream |
| | 703 | Media Preparation System |
| | 704 | Content Decisioning System |
| | 705 | Get program Content Channel ID Pass |
| | | users details (IP UserAgent Device ID etc) |
| | 706 | Get or enqueue for transcoding. |
| | | Params Channel ID (Media) |
| | 707 | Checks if a media is already transcoded. Else it |
| | | enqueues in transcoding queue for transcoding. |
| | 708 | Decisioning Engines |
| | 709 | Array of Media to stitch for an |
| | | user is sent as response. Ex: Stream |
| | | [Media1, Media2, Media3, . . . ] |
| | 710 | EPG Ingest |
| | 711 | Recommendation Engines |
| | 712 | Input Live Stream |
| 8 | 8000 | Ad Servers |
| | 8001 | Content Replacement |
| | 8002 | Live Stream |
| | 8003 | Media Preparation System |
| | 8004 | Replacement Decisioning system |
| | 8005 | Elastic Playout System |
| | 8006 | Ad Network (CAM, Pubmatic, etc) |
| | 8007 | Input Live Stream |
| | 8008 | VAST, VMAP responses |
| | 8009 | Replacement Engines |
| | 8010 | Get or queue for transcoding. |
| | | Params: Channel_ID [Media] |
| | 8011 | Array of Media to stitch for an |
| | | user is sent as response. Ex. Stream |
| | | [Media1, Media2, Media3] |
| | 8012 | Checks if a media is already transcoded. Else it |
| | | enqueues in transcoding queue for transcoding |
| | 8013 | Get replacement content {Replacement |
| | | marker type (ads, content live), chanelID, user |
| | | details (Ip useragent, DeviceID etc) |
| 9 | 800 | Elastic Playout system |
| | 801 | Content Decisioning System |
| | 802 | Replacement Decisioning System |
| | 803 | Media Preparation System |
| | 804 | Get live manifest |
| | 805 | Get live manifest for the channel |
| | | Fetch content form EPG, |
| | | Recommendation pr Delayed live |
| | 807 | Get segments from the content |
| | | assets matching the channel's |
| | | transcoding profiles |
| | 808 | Return live stream HLS or Dash manifest for the user |
| | 809 | Return array of segments to stich for channel's |
| | | transcoding profiles including the replacement markers |
| | 810 | Return array of segments for the content assets |
| | | matching the channel's transcoding profile |
| | 811 | Content mode |
| | 812 | Get replacement content for this user and channel |
| | 813 | Fetch Replacement content from ad-servers |
| | 814 | Get segments from the ad assets matching the channel's |
| | | transcoding profiles |
| | 815 | Return live stream HLS or Dash manifest |
| | | for the user with replaced content |
| | 816 | Return array of replacement segments to stich |
| | | which matches the channel's transcoding spec |
| | 817 | Return array of segments for the content assets |
| | | matching the channel's transcoding profiles |
| | 818 | Replacement mode |

What is claimed is:

1. A zero-slate system within Free Ad-supported Streaming TV (FAST) for creating personalized linear channels with the ability to i) avoid filler content during ad-breaks and ii) manage viewer-specific ad loads comprising (a) a Media Preparation System 300, (b) a content decisioning system 301, (c) an elastic playout system 303, (d) a replacement decisioning system 304 and (e) a media metadata store 302 wherein:
a) the Media Preparation System 300/500 for Zero Slate linear TV further comprises: (a) a media and metadata store 501, (b) an auto segmentation system 502, (c) a media preparation system 503, (d) a queue 509 and (e) a transcoder 504;
b) the Content Decisioning System 301 comprises (a) an EPG 700, (b) a Recommendation Engine 701, (c) a Delayed Live Stream 702, (d) a Content Decisioning System 704 and (e) a Media Preparation System 703;
c) the Replacement Decisioning System comprises (a) Ad Servers 800, (b) a content replacement module 801, (c) one or more livestream handlers 802, (d) a regional replacement decisioning system 804, (e) a media preparation system 803 and (f) an elastic playout system 805;
d) the Elastic Playout sub-component further comprises (a) a scheduler 600, (b) a user life-cycle manager 601, (c) a quartile tracker reporting sub-system 602, (d) a segment buffer builder 603, (e) a playlist builder 604, (f) a playlist server 605, (g) a load balancer 606 and (h) an EPS database 607.

2. The system of claim 1 where the Media Preparation System 300/500 the Media Preparation module further:
a) takes as inputs one or more downloadable URLs, various other sidecars, segmentation information, one or more destination paths where the transcoded asset has to be uploaded, transcoding profile information, various other transcoding parameters;
b) prepares as outputs segmented media segments that are uploaded to the destination path sending notifications about the status of the job;
c) the media preparation module uses the Media, the sidecars, transcoding profiles and its corresponding metadata like segment information to precondition the media into segments for streaming;
d) determines an adaptive bitrate (ABR) ladder for that media and chops the media and subtitles at soft-segment boundaries;
e) uses the soft-segmentation information that comes as input to precondition the media into chunks of segments;
f) uploads these segments are uploaded to a Blob store 507 and the entries are made in the database 508;
g) pre-determines transcoding profiles for a given Channel_ID;
h) stores one or more configurations for a Channel_ID;
i) stores in a blob store and database 506 what the customer ingests;
j) auto-generates segmentation information using a machine learning (ML)-based system;
k) generates metadata is generated that marks the content offset with respect to the start of media content where there is a scene change or audio change, which provides a replacement opportunity;
l) stores this information in (k) as in an associated metadata of the Media in Metadata store;
m) triggers transcoding and segmentation workflow for the newly created or updated media assets;
n) uploads to a blob-store 505 a corresponding index/master manifest of the individual soft-segmented assets;
o) returns a sequence of segments which fall within segment offset and segment duration in the Media; and
p) gets called by the Media & Metadata store 501 as and whenever there is a change or addition to any of the aspects of a Media.

3. The system of claim 2 where sidecars include subtitles, audios and URLs.

4. The system of claim 2 wherein machine learning (ML) models are used to detect scene boundaries in content to allow multiple options into the program content to introduce ad breaks.

5. The system of claim 2 wherein one or more algorithms utilizing scene changes, audio changes, including subtitles are used to determine the advertisement break points to provide oversampled replacement opportunities that allow the replacement decisioning module to leverage and effect interesting replacement policies.

6. The system of claim 2 wherein any changes to any of the sidecars or metadata also retrigger the transcoding workflow such that the transcoder 504 further:
a) uses transcoding profiles to create ABR ladder for the media assets;
b) uses the segmentation information to cleanly chop the ABR segmented assets at their segmentation boundaries; and
c) chops the corresponding sidecar assets at the segment boundaries.

7. The system of claim 2 wherein the corresponding soft-segment information to blob store URL link is further:
a) stored in the database; and
b) the segmented manifest is either in HLS or DASH format.

8. The system of claim 1 wherein the Content Decisioning System further comprises:
a) the EPG 700 which takes in an EPG ingest 710 and parses the EPG responses into a timeline of assets and when requested, it returns the media that is supposed to be played out at the current time;
b) the Recommendation Engine 701 parses the response from one or more recommendation engines 711 into an internal standardized format;
c) the Delayed Live Stream 702 parses live HLS, DASH or equivalent sources from input live streams 712 and brings them into an internal standardized format;
d) the Content Decisioning System 704 interacts with the EPG 700, the Recommendation Engine 701 and the Delayed Live Stream 702, exchanging an array of media to stitch for a user 709 and further interacts with the Media Preparation System 703 to get or enqueue items for transcoding 706; and
e) the Media Preparation System 703 checks if a media is already transcoded, failing which it enqueues it in a transcoding queue 707.

9. The system of claim 1 wherein the Replacement Decisioning System further comprises:
a) the Ad Servers 800 which interact with one or more ad networks 806 communicating in VAST/VMAP responses 809;
b) the Live Stream Handlers 802 parse the live HLS, DASH or equivalent sources of input live streams 807 and bring them into an internal standardized format;
c) the Replacement Decisioning System 804 interacts with Ad Servers 800, the content replacement module 801, and one or more livestream handlers 802 with an array of media to stitch for a user 811;
d) interacts with a Media Preparation System 803 to get or enqueue segments to transcode 810 and an Elastic Playout System (EPS) 805 to get replacement content 813; and
e) the Media Preparation System 803 checks if a media is already transcoded, failing which it enqueues it in a transcoding queue 812.

10. The system of claim 1 wherein the Ad Servers interact with one or more Ad Networks including GAM, PubMatic.

11. The system of claim 1 wherein the EPS further comprises (a) Scheduler 600, (b) User Life-Cycle Manager 601, (c) Quartile Tracker Reporting 602, (d) Segment Buffer Builder 603, (e) Playlist Builder 604, (f) Playlist Server 605, (g) Load Balancer 606, (h) EPS Database 607 wherein:
a) the Scheduler 600 triggers the playlist builder to build a manifest for active users; and triggers the segment buffer builder to extend the buffer if it is about to be exhausted and the segment buffer builder 603 in turn communicates with the EPS database 607 to set or extend a user's segment buffer by fetching from the content decisioning system or replacement decisioning system 608;
b) the user life-cycle manager 601 interacts with the EPS database 607 to store and periodically update user activity 613;
c) the quartile tracker reporting sub-system 602 interacts with one or more ad servers' quartile trackers 617 and the EPS database to get quartiles URLs for the user and the ad 611;
d) the segment buffer builder 603 prepares content from the content decisioning system or the replacement decisioning system 616;
e) the playlist builder 604 further:
i) builds a live stream for one or more users;
ii) consumes the users segment buffer to build the corresponding manifest; and
iii) exchanges user's state to manipulate and store the user's segment buffer 609.
f) the Playlist server 605 further:
i) interacts with the EPS database 607 to fetch a user's manifest from the database 610;
ii) interacts with the user life-cycle manager 601 to record user activity and user details 614; and
iii) interacts with the quartile tracker reporting sub-system 602 to send the ad quartile that the user has viewed 615.
g) the load balancer 606 requests users manifests 612; and
h) the EPS database 607 interacts with the segment buffer builder 603, the playlist builder 604, the user life-cycle manager 601, the Playlist server 605 and the quartile tracker reporting sub-system 602.

12. A computer-implemented method for zero-slate, within Free Ad-supported Streaming TV (FAST) for creating personalized linear channels with the ability to avoid filler content during ad-breaks and manage viewer-specific ad loads with (a) a Media Preparation System 803, (b) a content decisioning system (CDS) 801, (c) an elastic playout system (EPS) 800, and (d) a replacement decisioning system (RDS) 802, capable of operating in (i) content mode and (ii) replacement mode, comprising the steps of:
a) in content mode 811:
i) User requesting EPS for a live manifest 804;
ii) EPS requesting CDS 805 for assets to play in the present time window;
iii) the CDS talking to the EPS and a decisioning engine 806 to get the corresponding assets;
iv) the CDS getting one or more corresponding segments from the Media Preparation System 807;
v) the Media Preparation System responding 808 with one or more transcoded segments for the request 807;
vi) the CDS responding 809 with segments to the EPS in response to 805; and
vii) the EPS building a new playlist for the user request 804 and responding with the live manifest 810.
b) in replacement mode 818:
i) User requesting EPS for a live manifest 804;
ii) EPS requesting RDS 812 for assets to play in the present time window;
iii) the RDS talking to a replacement engine 813 to get the corresponding assets;
iv) the RDS getting one or more corresponding segments from the Media Preparation System 814;
v) the Media Preparation System responding 817 with one or more transcoded segments for the request 814;
vi) the RDS responding 816 with segments to the EPS in response to 812; and
vii) the EPS building a new playlist for the user request 804 and responding with the live manifest 810.

13. The computer-implemented method of claim 12 wherein the CDS talks to the EPS and a decisioning engine 806 which is an EPG.

14. The computer-implemented method of claim 12 wherein the CDS talks to the EPS and a decisioning engine 806 which is a Recommendation Engine.

15. The computer-implemented method of claim 12 wherein the CDS talks to the EPS and a decisioning engine 806 which is a delayed live stream.

16. A computer-implemented method of claim 12 wherein the RDS talks to the EPS 813 where:
a) a replacement engine returns one or more ad assets; or
b) a replace engine returns one or more replacement content segments; or
c) a replacement engine returns one or more live segments.

17. The computer-implemented method of claim 12 wherein the assets in b) include Channel_ID, user details, device details, EPG details, and trigger-type as inputs.

18. The computer-implemented method of claim 12 wherein the Ad server (a) has interactions exemplarily handled by ad-servers service, (b) the response expected from ad-servers is either VAST or VMAP.

19. The computer-implemented method of claim 12 wherein the EPS 800 further:
a) receives a live manifest for the channel. manifest for User requests the channel the manifest every ‘X’ seconds as long as the their session is active 804;
b) receives a Return array of replacement segments to stitch which matches the channel's transcoding spec 816 from the Replacement Decisioning Engine 802; and
c) sends a ‘Get live manifest for the channel’ 805, a ‘Get replacement content for this user and channel’ 812, a ‘Return live stream HLS or DASH manifest’ for the user 810 and a ‘Return live stream HLS or dash manifest for the user with replaced content’ 815.

20. The computer-implemented method of claim 12 wherein the Content Decisioning System 801 further:
a) receives a live manifest for the channel 805, content in response to the EPS talking to the Decisioning engine 806 and a ‘Return array of segments for the content assets matching the channel's transcoding profile's 808; and
b) sends ‘a Get segments from the content assets matching the channel's transcoding profiles’ 807 and a ‘Return array of segments to stitch for channel's transcoding profiles including the replacement markers’ 809.

21. The computer-implemented method of claim 12 wherein the Replacement Decisioning System 802 further:
a) receives a ‘Get replacement content for this user and channel’ 812, a segment from the EPS signaling the replacement engine 813 and ‘a Return array of segments for the content assets matching the channel's transcoding profiles; 817; and
b) sends a ‘Get segments from the ad assets matching the channel's transcoding profiles’ 814, and ‘a Return array of replacement segments to stitch which matches the channel's transcoding spec’ 816.

22. The computer-implemented method of claim 12 wherein the Media Preparation System 803 further:
a) receives ‘a Get segments from the content assets matching the channel's transcoding profiles’ 807, and a ‘Get segments from the ad assets matching the channel's transcoding profiles’ 814; and
b) sends a Return array of segments for the content assets matching the channel's transcoding profiles 808 and a Return array of segments for the content assets matching the channel's transcoding profiles 817.

23. A non-transitory, machine-readable storage medium having stored there on a computer program for zero-slate, within Free Ad-supported Streaming TV (FAST) for creating personalized linear channels with the ability to avoid slates/filler content during ad-breaks and manage viewer-specific ad loads with (a) a Media Preparation System 803, (b) a content decisioning system (CDS) 801, (c) an elastic playout system (EPS) 800, and (d) a replacement decisioning system (RDS) 802, capable of operating in (i) content mode and (ii) replacement mode, the computer program comprising a set of instructions for causing a machine to perform the steps of:
a) in content mode 811:
i) User requesting EPS for a live manifest 804;
ii) EPS requesting CDS 805 for assets to play in the present time window;
iii) the CDS talking to a decisioning engine 806 to get the corresponding assets;
iv) the CDS getting one or more corresponding segments from the Media Preparation System 807;
v) the Media Preparation System responding 808 with one or more transcoded segments for the request 807;
vi) the CDS responding 809 with segments to the EPS in response to 805; and
vii) the EPS building a new playlist for the user request 804 and responding with the live manifest 810.
b) in replacement mode 818:
i) User requesting EPS for a live manifest 804;
ii) EPS requesting RDS 812 for assets to play in the present time window;
iii) the RDS talking to a replacement engine 813 to get the corresponding assets;
iv) the RDS getting one or more corresponding segments from the Media Preparation System 814;
v) the Media Preparation System responding 817 with one or more transcoded segments for the request 814;
vi) the RDS responding 816 with segments to the EPS in response to 812; and
vii) the EPS building a new playlist for the user request 804 and responding with the live manifest 810.
